(19) United States
(12) Patent Application Publication
(10) Pub. No.: US 2018/0038695 A1
(43) Pub. Date: Feb. 8, 2018

(54) Generating Crowd-Sourced Navigation Data

(71) Applicant: QUALCOMM Incorporated, San Diego, CA (US)

(72) Inventors: Suresh Kumar Bitra, Mangalagiri (IN); Meghna Agrawal, Sunnyvale, CA (US)

(21) Appl. No.: 15/228,034

(22) Filed: Aug. 4, 2016

(51) Int. Cl. G01C 21/20; G01S 5/00; G01S 5/02; G08G 5/00; B64C 39/02

(52) U.S. Cl. CPC G01C 21/20; G08G 5/0069; G08G 5/0086; B64C 39/024; G01S 5/0205; G01S 5/0027; B64C 2201/00

(57) ABSTRACT

Various embodiments include methods and a server implementing the methods for generating crowd-sourced navigation data. The methods may include receiving, by a server, location data from a plurality of wireless communication devices, and generating, by the server, topological map data based on the location data received from the plurality of wireless communication devices. The location data received from the plurality of wireless communication devices may include an altitude, a latitude, and a longitude, and at least one of a medium access control address, a time stamp, a round trip time, a received signal strength indicator value, a reference signal received power value, a reference signal receive quality value, and a service set identifier. Methods may further include receiving location data from an unmanned aerial vehicle (UAV), generating navigation data relevant to the UAV using the generated topological map data, and transmitting the navigation data to the UAV.

### BACKGROUND

Unmanned aerial vehicles (UAVs), or drones, are used in a number of different applications. For example, UAVs may be used to deliver first aid and other supplies in emergency situations, transporting goods for commercial applications, surveying land, capturing photographs and videos, police and security monitoring, and recreational use.

UAVs may navigate in a variety of ways. For example, a user may manually control the flight path of the UAV. UAVs may also be equipped with Global Positioning System (GPS) navigation systems to allow drones to fly autonomously. However, the navigation data may not include the height of buildings, cell towers, and other structures necessary for a UAV to may maintain a safe flying altitude above obstacles.

### SUMMARY

Various embodiments include methods for generating crowd-sourced navigation data by a server. Various embodiments may include receiving location data from a plurality of wireless communication devices, and generating topological map data based on the location data received from the plurality of wireless communication devices.

In some embodiments, the plurality of wireless communication devices may include a plurality of mobile wireless communication devices. In some embodiments, the plurality of wireless communication devices may include a plurality of fixed wireless communication devices. In some embodiments, the plurality of wireless communication devices may include a plurality of mobile telephony network base stations.

In some embodiments, generating topological map data may include generating a topological map of structures based on the location data received from the plurality of wireless communication devices. In some embodiments, the topological map data may include a crowd density map based on location data received from mobile wireless communication devices among the plurality of wireless communication devices.

Some embodiments may further include receiving location information from an UAV, generating navigation data relevant to the UAV using the generated topological map data and the location information of the UAV, and transmitting the navigation data to the UAV. In some embodiments, generating navigation data relevant to the UAV may include generating a suggested travel route. Some embodiments may further include receiving location information from a UAV and transmitting the generated topological map data to the UAV. In some embodiments, receiving location data from a plurality of wireless communication devices may include receiving from the plurality of wireless communication devices an altitude, a latitude, and a longitude, and at least one of a medium access control address, a time stamp, a round trip time, a received signal strength indicator value, a reference signal received power value, a reference signal receive quality value, and a service set identifier.

In some embodiments, generating topological map data based on the location data received from the plurality of wireless communication devices may include updating previously generated topological map data based on the location data received from the plurality of wireless communication devices. In some embodiments, generating topological map data based on the location data received from the plurality of wireless communication devices may include correlating, by the server, the location data received from the plurality of wireless communication devices with map data from another source to generate a more complete topological map than available from such other source.

Further embodiments include a server including a processor configured with processor-executable instructions to perform operations of the methods summarized above. Further embodiments include a non-transitory processor-readable storage medium having stored thereon processor-executable software instructions configured to cause a processor of a server to perform operations of the methods summarized above. Further embodiments include a server that includes means for performing functions of the operations of the methods summarized above.

### BRIEF DESCRIPTION OF THE DRAWINGS

The accompanying drawings, which are incorporated herein and constitute part of this specification, illustrate exemplary embodiments of the claims, and together with the general description and the detailed description given herein, serve to explain the features of the claims.

FIG. 1 is a block diagram illustrating components of a typical unmanned aerial vehicle system suitable for use in various embodiments.

FIG. 2 is a block diagram illustrating components of a server suitable for use in various embodiments.

FIGS. 3A-3B are block diagrams illustrating a server generating navigation data form crowd-sourced location data according to various embodiments.

FIG. 4 is a process flow diagram illustrating a method for generating crowd-sourced navigation data and using such data to assist UAVs according to various embodiments.

FIG. 5 is a component block diagram of a server suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

UAVs and other autonomous vehicles may utilize a variety of data to enable the vehicles to navigate autonomously. For example, a UAV may utilize on-board GPS systems, sensors, cameras, and other components to determine the location of the UAV in three-dimensional (3D) space (e.g., latitude, longitude and altitude), and compare the determined location to map data stored in memory in order to autonomously navigate. A UAV may also receive navigation instructions, such as a flight path or series of waypoints forming a route, via a wireless connection with a server or a UAV controller. The navigation instructions may be generated by a server or manually input by a user.

In various embodiments, a server supporting UAV navigation may access a detailed topographical and geographical map database for information regarding topological features, minimum flight altitudes and no-fly zones in the areas in the UAV's flight path. The server may use such map data to provide navigation data to a UAV to enable the UAV to successfully navigate. The navigation data provided to a UAV may include a detailed topological database of the specific region in which the UAV is traveling, or a detailed flight path such as the location and altitudes of waypoints through which the UAV should pass. However, the server may not have sufficient information about various geographic features in order accurately provide navigation data.

Conventional topographic databases may not contain up to date information on the heights of buildings and cell towers. This may because topographic maps reflect only the ground elevations, ignoring structures. Topographic databases that include information on building heights may be out of date when new buildings are built. Also, construction cranes may be put up long before a building is completed and the height of the building included in topographic databases. Thus, there is a need for up to date topographic maps to aid in the guidance and control of UAVs.

Various embodiments use crowd-sourced data obtained from various wireless sources, such as wireless communication devices, Wi-Fi and Bluetooth beacons/access points, and mobile telephony network base stations to ensure that the detailed topographical and geographical map database used by a server to support UAV navigation includes accurate information on obstacles such as buildings and cellular base station antennas. Various embodiments may include receiving location and altitude information from a wide variety of fixed and mobile communication devices, and using this received location to generate and update a detailed topological map database. The location data may include the position and altitude information of each wireless source, as well as other information. The server may obtain the location data from mobile telephony network providers, over a wireless wide area network (WWAN), such as the Internet, via a wireless local area network (WLAN) connected to the Internet, and directly from some computing devices. For example, wireless communication devices may upload location data to the server via a Wi-Fi access point (or “hotspot”) data connection when the wireless communication devices (including UAVs) are within communication range.

The location and altitude data used by a server in generating 3D topological map data may be received from a wide variety of communication and computing devices. For example, cellular telephones (e.g., smartphones) typically include Global Positioning System (GPS) receivers and other precision location determining components that regularly inform the devices of their location in 3D space. The ubiquitous deployment of smartphones provides a crowd-source of precise location data that a server can use to estimate the location, configurations and altitudes of structures occupied by people. Such information will typically be up to date, as construction workers and crane operators will carry smartphones to the top of structures under construction. As another example, office buildings are typically equipped with wireless local area networks facilitated by wireless access points or Wi-Fi hotspots. The deployment of wireless access points thus provides another indication of occupied structures. Further, mobile telephony base stations (known as “eNodeB”) are typically deployed at the top of tall structures, including buildings and cell towers, in order to provide wider coverage areas. Thus, the geographic coordinates and altitude of mobile telephony base stations provides useful date regarding the topology of tall structures.

Gathering location 3D data from mobile communication devices (e.g., smartphones), a server may also determine the population density in various locations. Using such data, the server may be able to recognize locations with a high population density, which may be areas that UAV's should avoid flying over. Also, by using the altitude reported by each mobile communication device, the server may be configured to distinguish crowds gathered outdoors (e.g., in a stadium, an outdoor theater, or park) from people within in a tall office building.

By gathering data from a large number and wide variety of wireless communication devices, a server may generate detailed topological map data from crowd-source data. Such topological map data may include the latitude, longitude and height of structures determined from the crowd-source data. Topological map data may be assembled into one or more topological map databases. The server may be configured to use the topological map data or access topological map databases to generate navigation data that is transmitted to UAVs to support their navigation. Such navigation data may include an altitude map (i.e., a map including the locations and altitudes of structures), a crowd density map, a topographical map, a suggested travel route, and/or other navigation information.

The navigation data generated by the server may aid UAVs and other autonomous vehicles in conducting autonomous or semi-autonomous navigation. For example, the server may receive location information of a UAV in the geographical region and transmit relevant navigation data to the UAV to enable the UAV to travel through the geographical region. In some embodiments, the server may transmit to the UAV an altitude map from the server and determine a minimum flying height for the UAV while navigating through the geographical region. In some embodiments, the server may transmit to the UAV a suggested travel route through the geographical region, in which the travel route may avoid more crowded regions in the geographical region. Such a travel route may include 3D coordinates (i.e., latitude, longitude and altitude) through which the UAV should travel to avoid colliding with structures and/or posing a threat to people. In some embodiments, the server may transmit to the UAV both a suggested travel route and an altitude map for the region along the suggested route.

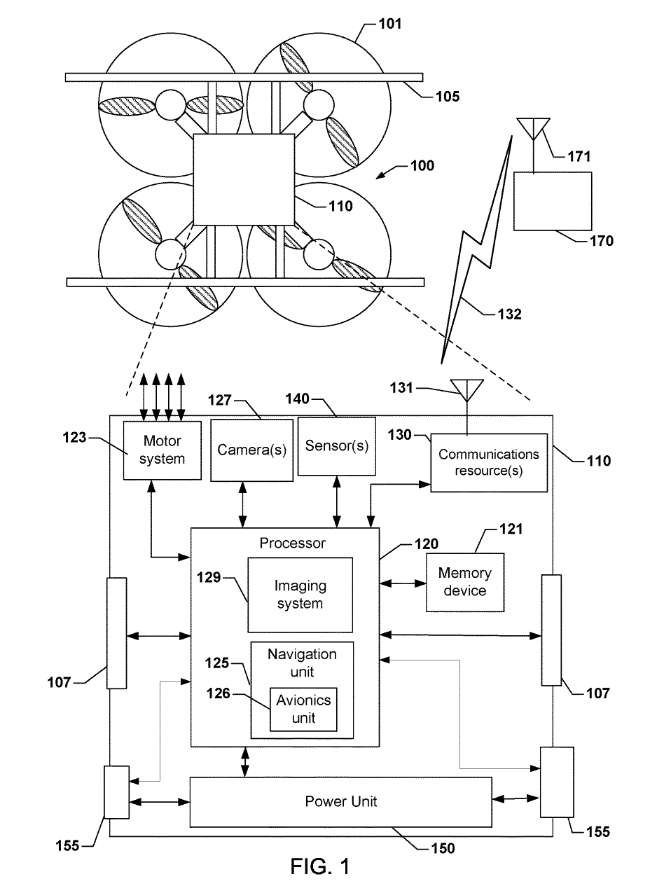

FIG. 1 illustrates an example UAV 100 for use with various embodiments disclosed herein. The UAV 100 is a “quad copter” having four horizontally configured rotary lift propellers, or rotors 101 and motors fixed to a frame 105. The frame 105 may support a control unit 110, landing skids and the propulsion motors, power source (power unit 150) (e.g., battery), payload securing mechanism (payload securing unit 107), and other components.

The UAV 100 may be provided with a control unit 110. The control unit 110 may include a processor 120, communication resource(s) 130, sensor(s) 140, and a power unit 150. The processor 120 may be coupled to a memory unit 121 and a navigation unit 125. The processor 120 may be configured with processor-executable instructions to control flight and other operations of the UAV 100, including operations of various embodiments. In some embodiments, the processor 120 may be coupled to a payload securing unit 107 and landing unit 155. The processor 120 may be powered from the power unit 150, such as a battery. The processor 120 may be configured with processor-executable instructions to control the charging of the power unit 150, such as by executing a charging control algorithm using a charge control circuit. Alternatively or additionally, the power unit 150 may be configured to manage charging. The processor 120 may be coupled to a motor system 123 that is configured to manage the motors that drive the rotors 101. The motor system 123 may include one or more propeller drivers. Each of the propeller drivers includes a motor, a motor shaft, and a propeller.

Through control of the individual motors of the rotors 101, the UAV 100 may be controlled in flight. In the processor 120, a navigation unit 125 may collect data and determine the present position and orientation of the UAV 100, the appropriate course towards a destination, and/or the best way to perform a particular function.

An avionics component 126 of the navigation unit 125 may be configured to provide flight control-related information, such as altitude, attitude, airspeed, heading and similar information that may be used for navigation purposes. The avionics component 126 may also provide data regarding the orientation and accelerations of the UAV 100 that may be used in navigation calculations. In some embodiments, the information generated by the navigation unit 125, including the avionics component 126, depends on the capabilities and types of sensor(s) 140 on the UAV 100.

The control unit 110 may include at least one sensor 140 coupled to the processor 120, which can supply data to the navigation unit 125 and/or the avionics component 126. For example, sensors 140 may include inertial sensors, such as one or more accelerometers (providing motion sensing readings), one or more gyroscopes (providing rotation sensing readings), one or more magnetometers (providing direction sensing), or any combination thereof. Sensors 140 may also include GPS receivers, barometers, thermometers, audio sensors, motion sensors, etc. Inertial sensors may provide navigational information, e.g., via dead reckoning, including at least one of the position, orientation, and velocity (e.g., direction and speed of movement) of the UAV 100. A barometer may provide ambient pressure readings used to approximate elevation level (e.g., absolute elevation level) of the UAV 100.

In some embodiments, the communication resource(s) 130 may include a GPS receiver, enabling Global Navigation Satellite System (GNSS) signals to be provided to the navigation unit 125. A GPS or GNSS receiver may provide three-dimensional coordinate information of the UAV 100 by processing signals received from three or more GPS or GNSS satellites. GPS and GNSS receivers can provide the UAV 100 with an accurate position in terms of latitude, longitude and altitude, and by monitoring changes in position over time, the navigation unit 125 can determine direction of travel and speed over the ground as well as a rate of change in altitude. In some embodiments, the UAV 100 navigation unit 125 may use an additional or alternate source of positioning signals other than GNSS or GPS. For example, the navigation unit 125 or a communication resource(s) 130 may include one or more radio receivers configured to receive navigation beacons or other signals from radio nodes, such as navigation beacons (e.g., very high frequency (VHF) omnidirectional range (VOR) beacons), Wi-Fi access points, cellular network sites, radio stations, etc. In some embodiments, the navigation unit 125 of the processor 120 may be configured to receive information suitable for determining position from the communication resource(s) 130. Because UAVs often fly at low altitudes (e.g., below 400 feet), the UAV 100 may scan for local radio signals (e.g., Wi-Fi signals, Bluetooth signals, cellular signals, etc.) associated with transmitters (e.g., beacons, Wi-Fi access points, Bluetooth beacons, small cells (picocells, femtocells, etc.), etc.) having known locations such as beacons or other signal sources within restricted or unrestricted areas near the flight path.

The UAV 100 navigation unit 125 may use location information associated with the source of the alternate signals together with additional information (e.g., dead reckoning in combination with last trusted GNSS/GPS location, dead reckoning in combination with a position of the UAV takeoff zone, etc.) for positioning and navigation in some applications. Thus, the UAV 100 may navigate using a combination of navigation techniques, including dead-reckoning, camera-based recognition of the land features below and around the UAV 100 (e.g., recognizing a road, landmarks, highway signage, etc.), etc. that may be used instead of or in combination with GNSS/GPS location determination and triangulation or trilateration based on known locations of detected wireless access points.

In some embodiments the control unit 110 may include a camera 127 and an imaging system 129. The imaging system 129 may be implemented as part of the processor 120, or may be implemented as a separate processor, such as an application specific integrated circuit (ASIC), a field programmable gate array (FPGA), or other logical circuitry. For example, the imaging system 129 may be implemented as a set of executable instructions stored in the memory unit 121 that execute on a processor 120 coupled to the camera 127. The camera 127 may include sub-components other than image or video capturing sensors, including auto-focusing circuitry, International Organization for Standardization (ISO) adjustment circuitry, and shutter speed adjustment circuitry, etc.

The control unit 110 may include one or more communication resources 130, which may be coupled to at least one transmit/receive antenna 131 and include one or more transceivers. The transceiver(s) may include any of modulators, de-modulators, encoders, decoders, encryption modules, decryption modules, amplifiers, and filters. The communication resource(s) 130 may be capable of device-to-device communication with other UAVs, wireless communication devices carried by a user (e.g., a smartphone), a UAV controller, and other devices or electronic systems (e.g., a vehicle electronic system).

The processor 120 and/or the navigation unit 125 may be configured to communicate communication resources 130 with a wireless communication device 170 through a wireless connection (e.g., a cellular data network) to receive assistance data from the server and to provide UAV position information and/or other information to the server. A bi-directional wireless communication link 132 may be established between transmit/receive antenna 131 of the communication resource(s) 130 and the transmit/receive antenna 171 of the wireless communication device 170. In some embodiments, the wireless communication device 170 and UAV 100 may communicate through an intermediate communication link, such as one or more wireless network nodes or other communication devices. For example, the wireless communication device 170 may be connected to the communication resources 130 of the UAV 100 through a cellular network base station or cell tower. Additionally, the wireless communication device 170 may communicate with the communication resources 130 of the UAV 100 through a local wireless access node (e.g., a Wi-Fi access point) or through a data connection established in a cellular network.

In some embodiments, the communication resource(s) 130 may be configured to switch between a cellular connection and a Wi-Fi connection depending on the position and altitude of the UAV 100. For example, while in flight at an altitude designated for UAV traffic, the communication resource(s) 130 may communicate with a cellular infrastructure in order to maintain communications with the wireless communication device 170. For example, the UAV 100 may be configured to fly at altitude of about 400 feet or less above the ground, such as may be designated by a government authority (e.g., the Federal Aviation Administration) for UAV flight traffic. At this altitude, it may be difficult to establish communication links with the wireless communication device 170 using short-range radio communication links (e.g., Wi-Fi). Therefore, communications with the wireless communication device 170 may be established using cellular telephone networks while the UAV 100 is at flight altitude. Communications with the wireless communication device 170 may transition to a short-range communication link (e.g., Wi-Fi or Bluetooth) when the UAV 100 moves closer to a wireless access point.

While the various components of the control unit 110 are illustrated in FIG. 1 as separate components, some or all of the components (e.g., the processor 120, the motor system 123, the communication resource(s) 130, and other units) may be integrated together in a single device or unit, such as a system-on-chip. The UAV 100 and the control unit 110 may also include other components not illustrated in FIG. 1.

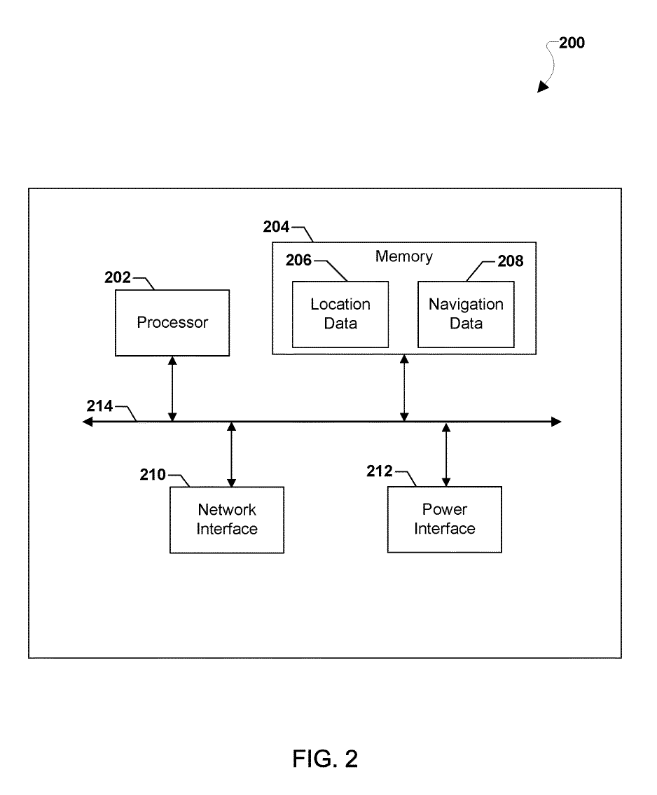

FIG. 2 is a functional block diagram of a server 200 suitable for implementing various embodiments. With reference to FIGS. 1-2, the server 200 includes a processor 202 for executing software instructions. The server 200 may include a memory for storing code and data. In some embodiments, the memory 204 may store crowd-sourced 3D location data 206 obtained from various wireless sources such as wireless communication devices, Wi-Fi or Bluetooth beacons/access points, and network base stations (e.g., eNodeBs) within one or more geographical regions. In some embodiments, the memory 204 may store a detailed topological map database generated from crowd-sourced 3D location data 206 obtained from various wireless sources such as wireless communication devices, Wi-Fi or Bluetooth beacons/access points, and network base stations (e.g., eNodeBs) within one or more geographical regions. The location data 206 received from crowd sources stored in the memory 204 and/or used to generate a topological map database may include the 3D position (e.g., latitude, longitude and altitude) of each wireless source, as well as other information such as, medium access control (MAC) address, date/time stamps of when the location data 206 was obtained, round trip time (RTT), a received signal strength indicator value, a reference signal received power value, a reference signal receive quality value, service set identifier (SSID), and/or the like.

In some embodiments, the memory 204 may store navigation data 208 that is generated from the location data 206. The processor 202 may calculate the navigation data 208 from the location data 206. The navigation data 208 may include altitude maps, topographical maps, crowd density maps, and suggested travel routes for the geographical regions in which the location data 206 was obtained. The memory 204 may include one or more of disk drives, random access memory (RAM), dynamic RAM (DRAM), static RAM (SRAM), read only memory (ROM), electrically erasable programmable ROM (EEPROM), or other types of non-transitory computer-readable storage media.

The server 200 may include a network interface 210. The network interface 210 may be configured to communicate with various networks such as mobile wireless network operators, WWANs (e.g., mobile telephony networks, the Internet) and local area networks (LANs). The server 200 may use the network interface 210 to collect the location data 206 from the wireless sources. The server 200 may also use the network interface 210 to transmit the navigation data 208 to other devices, such as UAVs (e.g., 100). In this manner, the server 200 may provide crowd-sourced navigation assistance to autonomous vehicles such as UAVs.

The server 200 may also include a power interface 212 for providing power to the server 200. The server 200 may include a bus 214 that connects the various components of the server 200 together.

The server 200 may also include various other components. For example, the server 200 may include a number of processing components such as modems, transceivers, subscriber identification module (SIM) cards, additional processors, additional hard drives, universal serial bus (USB) ports, Ethernet ports, and/or other types of wired or wireless input/output ports, keyboard, mouse, speaker, microphone, display screen, touchscreen, and many other components known in the art.

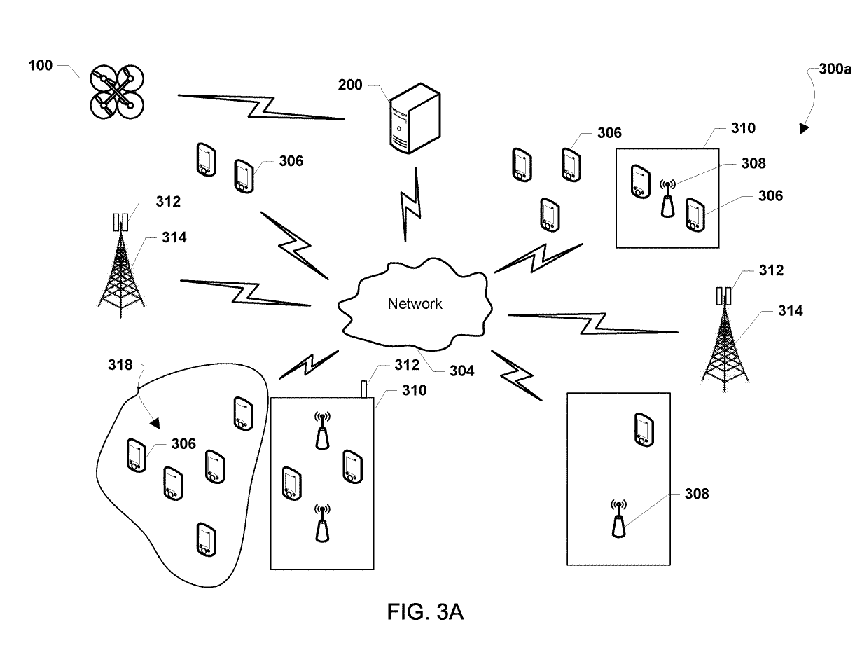

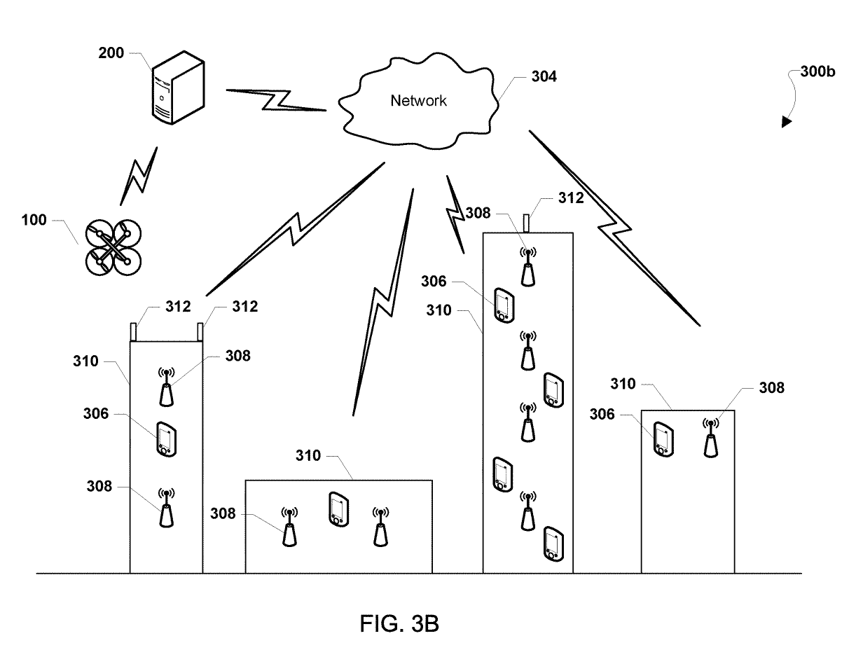

FIGS. 3A-3B are diagrams illustrating a plurality of wireless devices providing location data to a server (e.g., 200 in FIG. 2) configured to generate navigation data for UAVs (e.g., 100 in FIG. 1) from crowd-sourced location data obtained from the plurality of wireless sources according to various embodiments. With reference to FIGS. 1-3B, the diagram 300a includes the server 200 connected to a network 304. The network 304 may be a WWAN, such as a mobile telephony network or the Internet. In some embodiments, the network 304 may be a combination of networks, such as one or more WWANs connected to the Internet.

The diagram 300a also includes a number of wireless sources in a geographical region. The geographical region may be of any size or shape, such as one square kilometer. The wireless sources may include a plurality of wireless communication devices 306, such as smartphones, desktop computers, laptops, tablets, smart watches, other UAVs, and other personal devices. Each of the wireless communication devices 306 may be carried or used by users that are in the geographical region. The wireless communication devices 306 may each be connected to the network 304, for example through mobile telephony network base stations 312 or through wireless beacons/access points 308.

The wireless sources may also include a plurality of fixed wireless communication nodes 308, such as mobile telephony network base stations 312 (known as “eNodeBs”), Wi-Fi access points, and Bluetooth beacons. Each of the fixed wireless communication nodes 308 and mobile telephony network base stations 312 may be connected to the network 304, and configured to communicate location data to the server 200. Additionally, UAVs in the area communicating with/via Wi-Fi access points or mobile telephony network base stations 312 may communicate location and altitude data to the server 200. While the altitude of a UAV may not directly indicate the height of structures while in-flight, altitude reports when landed (a status that may be included in location reports) may provide a better indication. Additionally, altitude reports from flying UAVs may be helpful in defining the perimeters of structures when UAVs report flying at altitudes below the altitudes reported by near-by fixed structures, such as cell towers. There may be other wireless sources in the geographical region not illustrated in the diagrams 300a, 300b.

The server 200 may obtain location data from each of wireless sources in the geographical region through the network 304. The location data may include, but are not limited to, position, altitude, latitude, longitude, date/time when the location data is obtained, MAC address of the wireless source, RTT, a received signal strength indicator value, a reference signal received power value, a reference signal receive quality value, SSID, and/or the like. Some of the location data may be obtained from GPS systems in each of the wireless sources. For example, each mobile telephony network base station 312 may transmit its location data to the server 200 through the network 304, and may also transmit location data for each wireless communication device 306 that is connected to each network base station 312. Mobile telephony network base stations 312 are typically positioned on top of buildings 310 and cell towers 314, and thus their 3D location data provides an accurate measure of the altitude and location of such structures. In buildings that do not have a mobile telephony network base station 312, the 3D locations of local area network wireless base stations (e.g., Wi-Fi routers) within the building will provide information regarding the highest floor on which such networks are deployed. Each beacon/access point 308 may transmit its location data to the server 200, as well as carry communications from connected wireless communication devices 306 that convey to the server 200 each device's 3D location data.

In various embodiments, the server 200 uses location data received from the various wireless sources to generate detailed topological map data including the location and altitude of structures indicated by the presence of the wireless sources.

In addition to (or alternatively to) generating a topological map of structures, the server 200 may generate a crowd density map of people in the geographical region from the location data received from wireless communication devices 306. As mobile communication devices, such as smartphones, are becoming a standard accessory of most people, the locations of mobile communication devices 306 provides a good source of information for calculating the population density in a given location. The server 200 may use such a crowd density map to generate a suggested travel route for a UAV 100 to avoid flying over crowds (e.g., outdoor stadiums, parks, etc.) within a geographical region, avoid areas with relative high congestion of other people, UAVs, etc. The server 200 may, for example, utilize the crowd density map to suggest a travel route that avoids the most crowded parts of the region (e.g., region 318). The server 200 may transit to the UAV 100 via the network 304 the suggested travel route and/or the generated crowd density maps.

The diagram 300b illustrates how the server 200 may generate an altitude map and/or a topographical map from the location data received from many wireless communication devices. For example, some of the wireless communication devices 306 and the beacons/access points 308 may be located on various floors of the buildings 310 including the top floor. Also, as mentioned, mobile telephony network base stations 312 are typically deployed on the top of high buildings 310 and near the top of cellular base station antennas 314. The location data may include the height/altitude of each of the wireless sources such that the server 200 may approximate the height of buildings 310, cell towers 314 and other structures in the geographical regions. The server 200 may also approximate the height of various natural features in the geographical region (e.g., hills) from wireless sources located on the natural features (e.g., the wireless communication devices 306 or the network base stations 312).

The server 200 may transmit the altitude map and/or topographical map to the UAV 100 (or entity controlling or planning a flight path of the UAV 100) through the network 304. The UAV 100 may utilize the altitude map and/or topographical map to determine a minimum flying height through the geographical region.

In various embodiments, large numbers of wireless communication devices 306, wireless base stations 308, and/or the network base stations 312 may be configured with processor-executable instructions (e.g., a software application) to periodically determine the device's 3D location (e.g., access a stored location from memory in fixed devices or obtain a 3D fix from a GPS/GNSS receiver), and report the 3D location data to the server 200 using whatever network connection is available. For example, the wireless communication devices 306 may be scanning and listening for WLAN and/or WWAN signals as part of its regular camping procedures, as well as navigation (e.g., using trilateration from WLAN and WWAN access points to supplement GPS navigation). For example, the wireless communication devices 306 may subscribe to one or more WWAN mobile telephony networks such as Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), and Universal Mobile Telecommunications Systems (UMTS).

When a wireless communication device receives a signal, the wireless communication device may obtain its GPS position, for example from a GPS application executing on the wireless communication device. The wireless communication device may tag the WLAN or WWAN system ID (e.g., one or more of MAC address, SSID, mobile country code (MCC), mobile network code (MNC), location area code (LAC), and cell identifier (CID)) with the GPS position of the wireless communication device. The wireless communication device may also include additional information, such as the current time, received signal strength indicator (RSSI), reference signal received power (RSRP), and reference signal receive quality (RSRQ) values. If the wireless communication device does not have its GPS position, the device may use other location information such as venue details (e.g., park name, hotel name, etc.) or may not tag its location to the WLAN or WWAN system ID. The wireless communication device 306 may continue collecting and tagging the location data according to a crowdsource timeout configuration. Upon expiry of the timeout, the wireless communication device may send the location data, tagged system ID's, and other information, along with the wireless communication device's unique identifier (e.g., international mobile station equipment identity (IMEI)) to the server 200 using a WLAN or WWAN wireless connection.

The server 200 may receive the location and associated data from the wireless communication device 306. Over time, the server 200 may utilize the received location data reports to determine the average number of devices (and thus people) present at various locations and also how the crowd density varies with time. This statistical analysis by the server 200 may be used to determine crowd density at various locations as a function of time of day, day of week and holidays. The server 200 may use such averaged crowd density information to provide navigation assistance to the UAV 100, such as to enable the UAV to avoid flying over crowds.

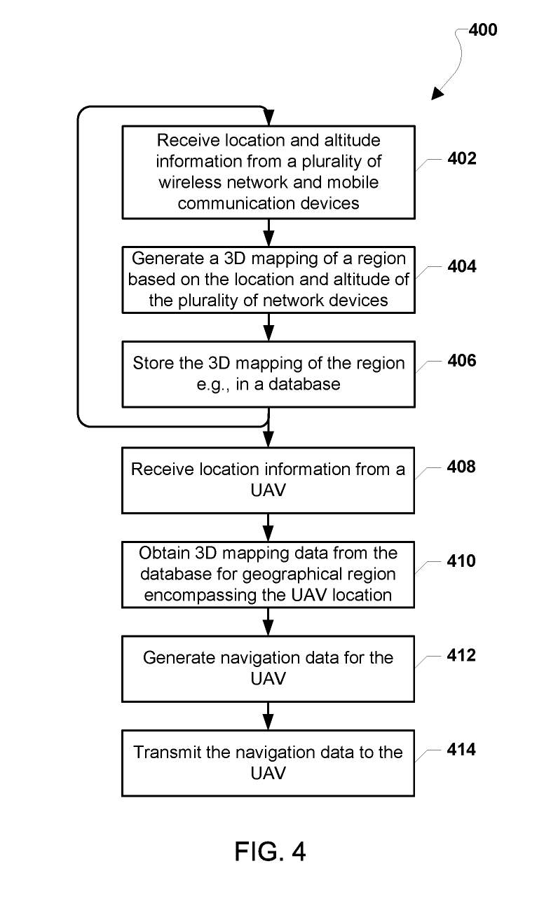

FIG. 4 illustrates a method 400 for generating crowd-sourced navigation data according to various embodiments. With reference to FIGS. 1-4, the operations of the method 400 may be performed by a server (e.g., the server 200) such as by a processor within the server (e.g., by the server processor 202) executing processor-executable instructions implementing the method 400. The server may be connected to a network, such as the Internet and one or more mobile telephony networks.

In block 402, the server may receive location data from a plurality (i.e., a crowd) of wireless network and mobile communication devices. The wireless network and mobile communication devices may include, but are not limited to, wireless communication devices, Wi-Fi access points, Bluetooth beacons, and telephony network base stations. The server may receive the location data from wireless sources through the network. For example, each network base station and Wi-Fi access point may transmit location data of each wireless communication device connected to the base station/access point. In some embodiments, each network base station and Wi-Fi access point may also transmit its own location data to the server. In other embodiments, the location of each network base station and Wi-Fi access point may be determined from the location data of the wireless communication devices (e.g., from WLAN or WWAN IDs tagged to the location data of the wireless communication devices). The location data may include, but are not limited to, position, altitude, latitude, longitude, date/time when the location data is obtained, MAC address of the wireless source, RTT, a received signal strength indicator value, a reference signal received power value, a reference signal receive quality value, and SSID of each wireless source. The server may obtain and store location data from multiple geographical regions, for example, within one square kilometer tiles.

In block 404, the server may generate or update a topological (i.e., 3D) mapping of the region based on the locations and altitudes of the plurality of wireless network and mobile communication devices providing data. This operation may involve plotting the locations of each device in a map based on the received coordinates and linking each location to an associated altitude. Alternatively, this operation may involve generating or updating a 3D map of reported coordinates. This operation may also include correlating received location and altitude data with other map data, such as electronic maps provided by various sources, including government and/or commercial maps (e.g., Google maps). Such correlation of received location and altitude data with other map data may include expanding the altitude of a building to encompass the full area of the building as recorded in the other map data. In other words, the generation of a topological map or topological map database in block 404 may involve expanding the information available in government and/or commercial maps to reflect the determined altitude of structures, or adding structures (e.g., cell towers) not shown in the government and/or commercial maps. Thus, correlating the location data received from the plurality of wireless communication devices with map data from another source may enable the server to generate a more complete topological map than is available from such other source.

The generated or updated topological mapping produced in block 404 may also include determining or updating the crowd density at various locations based on the crowd-sourced location data received in block 402.

In block 406, the server may store the generated or updated 3D mapping of the region in an accessible format, such as a database stored on a memory device (e.g., hard disk memory) accessible to the server.

The server may receive location data from various wireless network and mobile communication devices continuously or periodically in block 402, and may repeat the operations of updating topological mapping data in block 404 and storing such updated topological data in block 406 continuously or periodically. For example, the server may maintain an up to hour mapping of the crowd density based upon location reports received from smartphones.

In block 408, the processor may receive location information of a UAV, such as part of a request from the UAV for navigation data or route planning data. The UAV may contact the server to request navigation data at the start of a mission, periodically during a mission, in response to an event during a mission (e.g., upon reaching a boundary of a region or determine the need to deviate from a flight path). The UAV may transmit its location information to the server (e.g., position, altitude) to enable the server to determine a subset of navigation data most relevant to the UAV. The UAV may also transmit a mission or flight plan that the UAV is following to enable the server to determine a subset of navigation data most relevant to the UAV over the course of the planned mission. In some embodiments, the location information may include the ID or other information identifying the current WLAN access point or network base station on which the UAV is currently camped. In such embodiments, the server may determine the approximate location of the UAV from the location of the access point or network base station. The server and the UAV may communicate through a network, such as the Internet and/or one or more mobile telephony networks.

In block 410, the server may access the stored 3D mapping data to obtain 3D mapping data for the geographic region encompassing the UAV's reported location. The server may also access 3D mapping data encompassing a mission profile or flight plan of the UAV (either reported by the UAV or known to the server).

In block 412, the server may generate navigation data for the UAV relevant to the location of the UAV. For example, the server may use the topological data to provide an altitude map for the vicinity and/or along the flight path of the UAV. As another example, the server may use information regarding crowd density to generate a crowd density map or crowd density data in the vicinity and/or along the flight path of the UAV. As another example, the server may generate a suggested travel route through a geographical region including minimum flight altitudes at each point along the route. The suggested travel route may, for example, avoid crowded areas in the geographical region.

The navigation data generated in block 412 may be a subset of topological map data limited to a size that can be transmitted to the UAV within available bandwidth and stored in the memory of the UAV. Thus, part of the operations in block 412 may involve selecting, summarizing, formatting, compressing or otherwise transforming the large amount of information that may be generated from crowd-source location data into a form that can be transmitted to, stored on, and used by a UAV. Such transformation of the navigation data may depend upon the particular capabilities (e.g., memory size and processing power) of the UAV as well as the current characteristics or available bandwidth of the communication link to the UAV.

In block 414, the processor may transmit the generated navigation data to the UAV (or entity controlling or planning a flight path of the UAV). The UAV may utilize the navigation data to travel through the geographical region. For example, the UAV may travel along the suggested travel route, or independently plot a travel route based on the crowd density map and other information. The UAV may also determine a minimum flying height based on the altitude or topographical map. In some embodiments, the server may communicate with various UAVs and other autonomous vehicles and provide navigation data to each vehicle based on each UAV's location. In this manner, the method 400 provides a way to generate crowd-sourced topological data from various wireless sources useful for generating navigation data for UAVs.

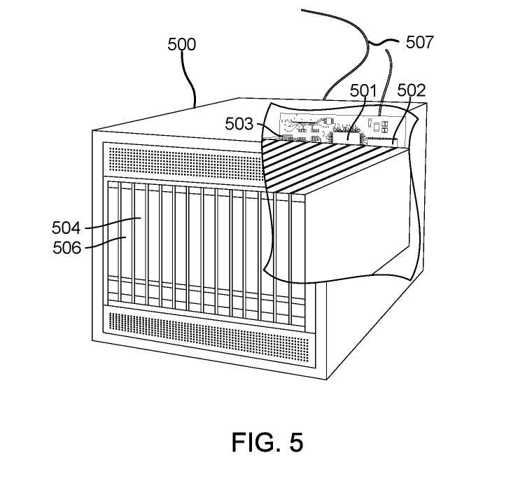

The various embodiments may also be implemented on any of a variety of commercially available server devices, such as the server 500 illustrated in FIG. 5. With reference to FIGS. 1-5, the server 500 typically includes a processor 501 coupled to volatile memory 502 and a large capacity nonvolatile memory, such as a disk drive 504. The server 500 may also include a floppy disc drive, compact disc (CD) or digital versatile disc (DVD) disc drive 506 coupled to the processor 501. The server 500 may also include network access ports 503 coupled to the processor 501 for establishing network interface connections with a network 507, such as a local area network coupled to other broadcast system computers and servers, the Internet, the public switched telephone network, and/or a cellular data network. Examples of mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1×RTT), and Universal Mobile Telecommunications Systems (UMTS).

The various processors described herein may be any programmable microprocessor, microcomputer or multiple processor chip or chips that can be configured by software instructions (applications) to perform a variety of functions, including the functions of various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The various embodiments illustrated and described are provided merely as examples to illustrate various features of the claims. However, features shown and described with respect to any given embodiment are not necessarily limited to the associated embodiment and may be used or combined with other embodiments that are shown and described. In particular, various embodiments are not limited to use on aerial UAVs and may be implemented on any form of UAV that use navigation data. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, compact disc ROM (CD-ROM) or other optical disk storage, magnetic disk storage or other magnetic storage smart objects, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method for generating crowd-sourced navigation data, the method comprising:
receiving, by a server, location data from a plurality of wireless communication devices; and
generating, by the server, topological map data based on the location data received from the plurality of wireless communication devices.

2. The method of claim 1, further comprising:
receiving, by the server, location information from an unmanned aerial vehicle (UAV);
generating, by the server, navigation data relevant to the UAV using the generated topological map data and the location information of the UAV; and
transmitting, by the server, the generated navigation data to the UAV.

3. The method of claim 2, wherein generating, by the server, navigation data relevant to the UAV comprises generating, by the server, a suggested travel route.

4. The method of claim 1, further comprising:
receiving, by the server, location information from an unmanned aerial vehicle (UAV); and
transmitting, by the server, the generated topological map data to the UAV.

5. The method of claim 1, wherein generating topological map data comprises generating, by the server, a topological map of structures based on the location data received from the plurality of wireless communication devices.

6. The method of claim 1, wherein the generated topological map data comprises a crowd density map based on the location data received from mobile wireless communication devices among the plurality of wireless communication devices.

7. The method of claim 1, wherein receiving, by the server, location data from the plurality of wireless communication devices comprises receiving from the plurality of wireless communication devices an altitude, a latitude, and a longitude, and at least one of a medium access control address, a time stamp, a round trip time, a received signal strength indicator value, a reference signal received power value, a reference signal receive quality value, and a service set identifier.

8. The method of claim 1, wherein generating topological map data based on the location data received from the plurality of wireless communication devices comprises updating, by the server, previously generated topological map data based on the location data received from the plurality of wireless communication devices.

9. The method of claim 1, wherein generating topological map data based on the location data received from the plurality of wireless communication devices comprises correlating, by the server, the location data received from the plurality of wireless communication devices with map data from another source to generate a more complete topological map than available from such other source.

10. The method of claim 1, wherein the plurality of wireless communication devices comprises a plurality of mobile wireless communication devices.

11. The method of claim 1, wherein the plurality of wireless communication devices comprises a plurality of fixed wireless communication devices.

12. The method of claim 1, wherein the plurality of wireless communication devices comprises a plurality of mobile telephony network base stations.

13. A server for generating crowd-sourced navigation data, comprising:
a memory; and
a processor coupled to the memory and configured with processor-executable instructions to:
receive location data from a plurality of wireless communication devices; and
generate topological map data based on the location data received from the plurality of wireless communication devices.

14. The server of claim 13, wherein the processor is further configured with processor-executable instructions to:
receive location information from an unmanned aerial vehicle (UAV);
generate navigation data relevant to the UAV using the generated topological map data and the location information of the UAV; and
transmit the generated navigation data to the UAV.

15. The server of claim 14, wherein the processor is further configured with processor-executable instructions to generate navigation data relevant to the UAV in the form of a suggested travel route.

16. The server of claim 13, wherein the processor is further configured with processor-executable instructions to:
receive location information from an unmanned aerial vehicle (UAV); and
transmit the generated topological map data to the UAV.

17. The server of claim 13, wherein the processor is further configured with processor-executable instructions to generate topological map data by:
generating a topological map of structures based on the location data received from the plurality of wireless communication devices.

18. The server of claim 13, wherein the topological map data comprises a crowd density map based on location data received from mobile wireless communication devices among the plurality of wireless communication devices.

19. The server of claim 13, wherein the processor is further configured with processor-executable instructions to receive location data from the plurality of wireless communication devices in the form of an altitude, a latitude, and a longitude, and at least one of a medium access control address, a time stamp, a round trip time, a received signal strength indicator value, a reference signal received power value, a reference signal receive quality value, and a service set identifier.

20. The server of claim 13, wherein the processor is further configured with processor-executable instructions to update previously generated topological map data based on the location data received from the plurality of wireless communication devices.

21. The server of claim 13, wherein the processor is further configured with processor-executable instructions to generate topological map data by:
correlating the location data received from the plurality of wireless communication devices with map data from another source to generate a more complete topological map than available from such other source.

22. The server of claim 13, wherein the plurality of wireless communication devices comprises a plurality of mobile wireless communication devices.

23. The server of claim 13, wherein the plurality of wireless communication devices comprises a plurality of fixed wireless communication devices.

24. The server of claim 13, wherein the plurality of wireless communication devices comprises a plurality of mobile telephony network base stations.

25. A non-transitory computer readable storage medium having stored thereon processor-executable software instructions configured to cause a processor of a server to perform operations comprising:
receiving location data from a plurality of wireless communication devices; and
generating topological map data based on the location data received from the plurality of wireless communication devices.

26. A server for generating crowd-sourced navigation data, comprising:
means for receiving location data from a plurality of wireless communication devices; and
means for generating topological map data based on the location data received from the plurality of wireless communication devices.
